(19) United States
(12) Patent Application Publication
(10) Pub. No.: US 2020/0205204 A1
(43) Pub. Date: Jun. 25, 2020

(54) WIRELESS NETWORK TOPOLOGY USING SPECULAR AND DIFFUSED REFLECTIONS

(71) Applicant: ARRIS Enterprises LLC, Suwanee, GA (US)

(72) Inventors: Michael J. Shaw, Granite Bay, CA (US); Bobby Dale Latham, Grass Valley, CA (US); Viswanath B. Rao, Auburn, CA (US)

(21) Appl. No.: 16/227,983

(22) Filed: Dec. 20, 2018

(51) Int. Cl. H04W 76/10; H01Q 19/12; H04B 7/145; H04W 16/20; H04W 72/04; H04W 16/12

(52) U.S. Cl. CPC H04W 76/10; H01Q 19/12; H04B 7/145; H04W 84/12; H04W 72/0453; H04W 16/12; H04W 16/20

(57) ABSTRACT

Systems and methods for communicating signals between an access point and a client device in a wireless network. The access point and the client device may each have directional antennas respectively aimed in directions substantially not toward the directional antenna of the other device.

### CROSS REFERENCE TO RELATED APPLICATIONS

None

### BACKGROUND

The subject matter of this application relates to wireless networks and more particularly to systems and methods that improve throughput of wireless network data.

A wireless local area network (WLAN) typically includes one or more access points (APs) that provide shared wireless communication channels for use by a number of client devices or stations (STAs), along with at least one gateway, which may for example be a router or any other device capable of transmitting and receiving signals to/from the respective APs and relaying signals to and from a wired network.

Most wireless networks are configured to operate on the 2.4 or 5.0 GHz frequency bands—e.g., IEEE 802.11b, 802.11g, 802.11n, 802.11ac—and utilize omnidirectional antenna arrays to establish communications channels that can readily move around obstructions between linked network devices, such as walls, furniture, cubicles, etc. Even where signals between devices in the network (e.g., between an STA and an AP) are impeded or otherwise degraded by such obstructions, adequate bandwidth can be restored through the use of repeaters and/or extenders throughout the wireless network.

Unlike the wireless network standards described above, 802.11ad operates on a much higher frequency band—i.e., frequencies between 57 and 66 GHz. The advantage of such high frequencies is that much more data can be transmitted, easily enabling 4K video streams to be transmitted wirelessly for example. However, signals transmitted at such high frequencies do not propagate over as large a distance as wireless signals at lower frequencies.

What is desired, therefore, are systems and methods that increase the range of wireless signals transmitted over frequencies as high as 66 GHz.

### SUMMARY OF THE DISCLOSURE

In a first embodiment of the disclosure, an arrangement configured to establish a wireless network may comprise an access point and a client device. The access point may have a first directional antenna configured to transmit at a frequency between approximately 55 GHz and 65 GHz. The client device may have a second directional antenna configured to receive signals from the access point at a frequency between approximately 55 GHz and 65 GHz. The first directional antenna may be aimed in a direction substantially not toward the second directional antenna, and the second directional antenna may be aimed in a direction substantially not toward the first directional antenna.

In the context of the first embodiment, the phrase “aimed in a direction” refers to the direction along which the directional antenna is oriented to transmit signals, or receive signals, or both. Also, in the context of the first embodiment, the phrase “aimed in a direction not substantially toward” an antenna of the other device means that the antenna is aimed in a direction such that any signal propagating around a linear axis continuously along that direction would not be communicated to or from the other antenna without significant signal degradation.

A second embodiment of the disclosure may comprise a method for establishing a wireless communications network for exchanging signals between an access point having a first directional antenna and a client device having a second directional antenna. The method may include the steps of aiming the first directional antenna in a direction substantially not toward the second directional antenna, and aiming the second directional antenna in a direction substantially not toward the first directional antenna; where the client device receives a signal propagated from the access point.

In the context of the second embodiment, the phrase “aimed in a direction” refers to the direction along which the directional antenna is oriented to transmit signals, or receive signals, or both. Also, in the context of the first embodiment, the phrase “aimed in a direction not substantially toward” an antenna of the other device means that the antenna is aimed in a direction such that any signal propagating around a linear axis continuously along that direction would not be communicated to or from the other antenna without significant signal degradation.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates free path loss in signal strength due to atmospheric oxygen and water as a function of signal frequency.

FIGS. 2A and 2B show respective test configurations in upstairs and downstairs floorplans of an office environment used to test signal strength of a 60 GHz wireless communications channel.

FIG. 3A shows a graph of signal strength as a function of distance in the upstairs test configuration of FIG. 3A.

FIG. 3B shows respective graphs of signal strength as a function of time in a line of sight hallway test in the downstairs test configuration of FIG. 4B, and an obstructed path test in the downstairs test configuration of FIG. 4B.

FIG. 4 shows several test configurations and test results in a home environment used to test signal strength of a 60 GHz wireless communications channel.

FIG. 5 shows a test configuration in an office environment testing the effect that specular reflections have on the signal strength of a 60 GHz wireless communications channel.

FIG. 6 shows a test configuration in an office environment testing the effect that diffuse reflections have on the signal strength of a 60 GHz wireless communications channel.

FIG. 7 shows an alternate embodiment using a near-field reflector to increase the coverage area of a signal from a directional antenna.

### DETAILED DESCRIPTION

As noted earlier, wireless propagation loss is a significant disadvantage when transmitting wireless signals at frequencies in the range of 60 GHz. Wireless propagation loss for 60 GHz signals can, in turn, be subdivided into three types of losses: (a) 60 GHz free space path loss; (b) propagation through building materials; and (c) losses due to resonance with oxygen. First, as a signal radiates away from an antenna, it will lose energy as the EM wave scatters away from the antenna. This “free space path loss,” denoted by L_{fs}, will be the dominant factor in the loss of signal energy as the transmitted signal moves away from the antenna:

L_{fs}=(λ/4πD)²=(c/4πfD)² Eqn (1)

where D is distance in meters, f is frequency in Hertz, λ is wavelength in meters, and c is the speed of light in free space. If respective antenna gains for the transmitter and receiver are considered, equation (1) can be expressed in logarithmic form as

L_{fs}=20 Log 10(D)+20 Log 10(f)+20 Log 10(4π/c)−Gt−Gr Eqn (2)

From this equation, there is an additional 20 dB loss in signal strength merely due to the use of a 60 GHz transmission channel relative to a 5.5 GHz channel.

With respect to propagation losses through building materials when using a 60 GHz transmission channel, the following chart shows several loss-related properties for different materials:

| | | Complex | | Scattering |
|---|---|---|---|---|
| Building | Thickness | Permittivity | Attenuation | Coefficient γ |
| Material | Δ [mm] | εᵣ | α [dB/cm] | [dB] |
| Cement | 193.7 | 3.3 − j0.38 | 11.3 | −17.1 |
| Cinderblock | | | | |
| Wall | | | | |
| Brick Wall | 92 | 2.55 − j0.43 | 14.7 | −17.3 |
| Cement | 12.7 | 3.0 − j0.54 | 17 | — |
| Backerboard | | | | |
| Drywall | 12.7 | 2.26 − j2.4*10⁻³ | 0.09 | −12.5 |
| Drywall with | 12.8 | 2.77 − j1.9*10⁻² | 0.6 | — |
| semigloss paint | | | | |
| Drywall with | 12.8 | 2.28 − j2.4*10⁻³ | 0.09 | −14.2 |
| flat paint | | | | |
| Plexiglass | 2.2 | 2.70 − j0.26 | 8.6 | — |
| Glass | 12.7 | 6.55 − j0.20 | 4.3 | — |
| Wood | 5.1 | 2.8 − j4.0*10⁻² | 1.3 | — |
| Ceiling Tile | 15.9 | 1.55 − j2.6*10⁻² | 1.12 | −11.9 |

Attenuation through these materials will affect the link budget within the network depending upon the configuration of walls and other items.

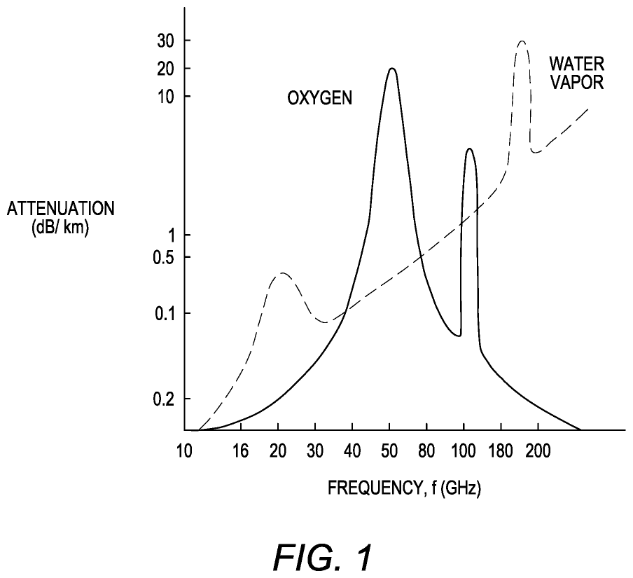

The third category of free space losses is the resonance with oxygen at 60 GHz propagation frequencies. FIG. 1 shows that resonance losses from oxygen peak at approximately 60 GHz and that resonance losses from water vapor add approximately 40% to those losses.

One technique of mitigating free space losses in 802.11ad wireless networks is to increase antenna gain and use directional antennas, aimed between network components, to focus signal power along a narrow path to overcome the free space losses described above. The present inventors conducted a variety of 802.11ad wireless network field tests to determine the efficiency of using high-gain directional antennas to communicate in an 802.11ad wireless network. For these tests, the inventors used two 802.11ac Qualcomm units modified to operate at 60 GHz, but equipped with 802.11ad array antennas. Each unit included a Linux installation that could perform independent iperf measurements. The UDP iperf test performed substandard compared to the TCP test so TCP was used. The maximum data rate measured from unit to unit was 1.2 Gbps; although the inventors noted that this was far short of the theoretical limitation of 4.6 Gbps for 802.11ad, the performance appeared caused by a bottleneck and per Qualcomm, the 1.2 Gbps data rate ceiling was to be expected.

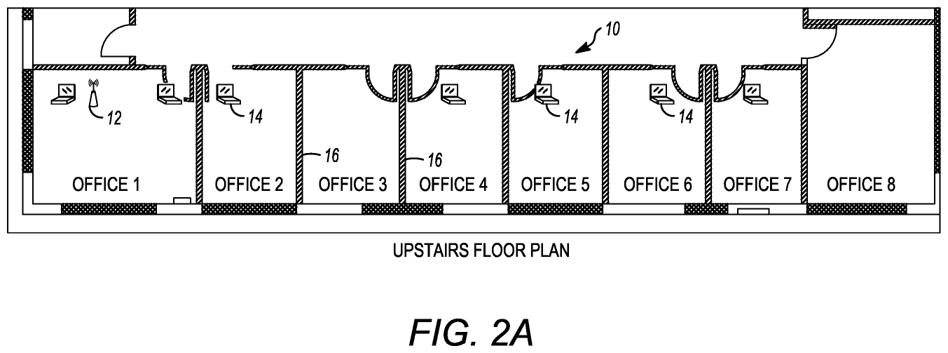

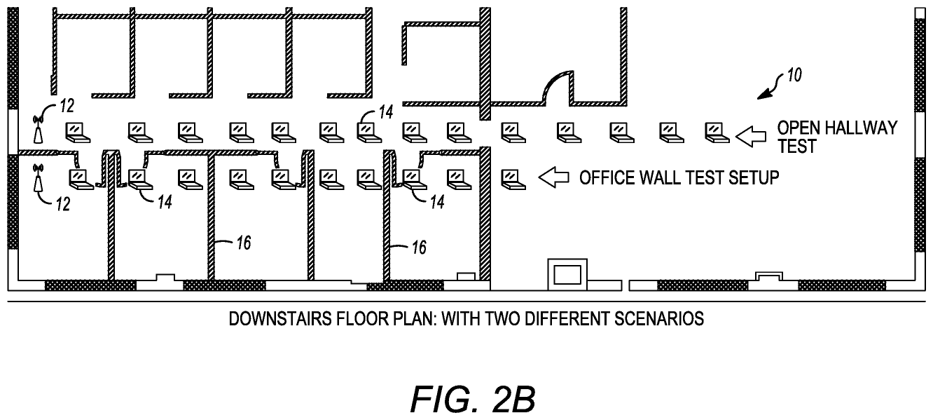

A field test of a 60 GHz wireless network was first performed in an office environment architecture with upstairs and downstairs floor plans shown in FIGS. 2A and 2B. The upstairs tests evaluated the performance of the wireless network 10 in a non-line-of-sight configuration that would be expected in an office environment where the wireless signal from the transmitter 12 would be received by receivers 14 (e.g., desktop computers or laptop) positioned inside offices surrounded by walls 16. The downstairs tests evaluated the performance of the wireless network 10 in both a non-line-of-sight configuration as described above as well as a line-of-sight configuration where receiving devices were placed along a hallway without any obstructions between them and the receiver.

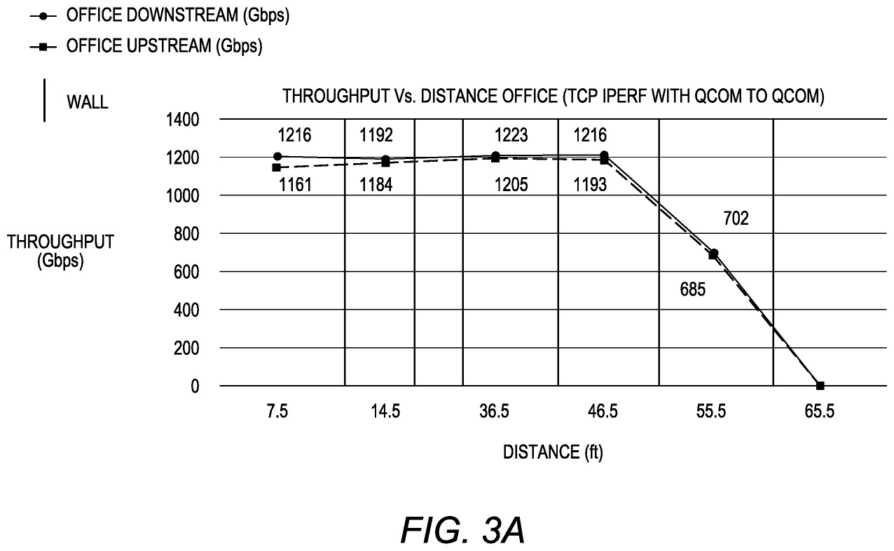

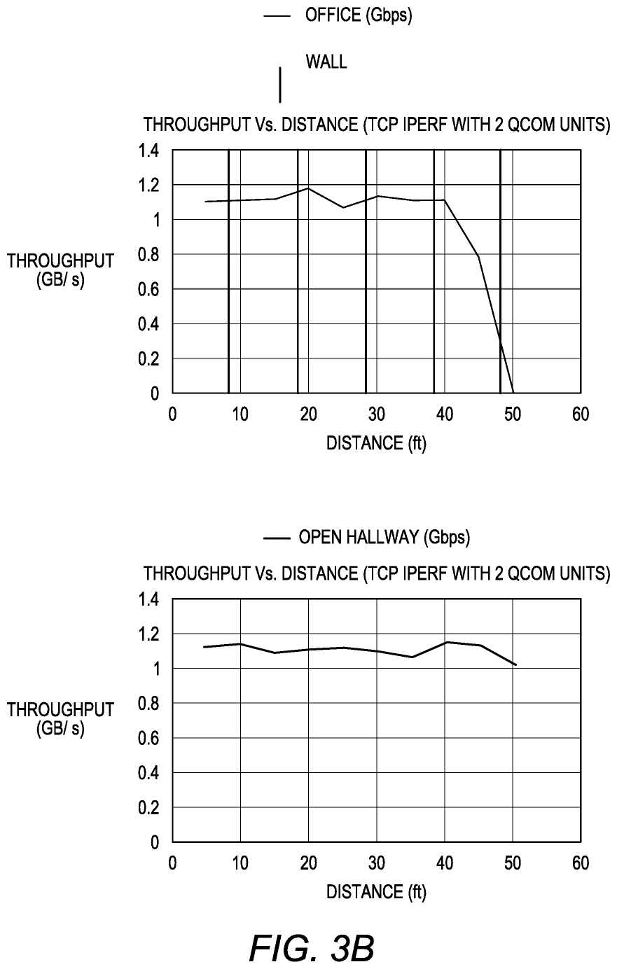

The results of the upstairs testing are generally shown in FIG. 3A. In offices where walls were in the path between the receiver and the transmitter, the throughput maintains a level of about 1.2 Gbps through 4 walls, and up to a distance of 46.5 feet. With the fifth wall introduced, at an additional distance of 9, the throughput drops to 0.700 Gbps. In the sixth office, the connection between the transmitter and receiver repeatedly dropped and reconnected, though at times the throughput reaches 700 Mbps, hence it was assumed that the data from that location was not reliable.

The results of the downstairs testing are generally shown in FIG. 3B. As can be seen from these results, regardless of obstructions the signal strength between the transmitter and the receiver generally held steady through four walls at approximately 1.1 Gbps in the downstream and upstream directions; however, when the transmitter and receiver were separated by five walls, performance declined rapidly, and connection was quickly lost.

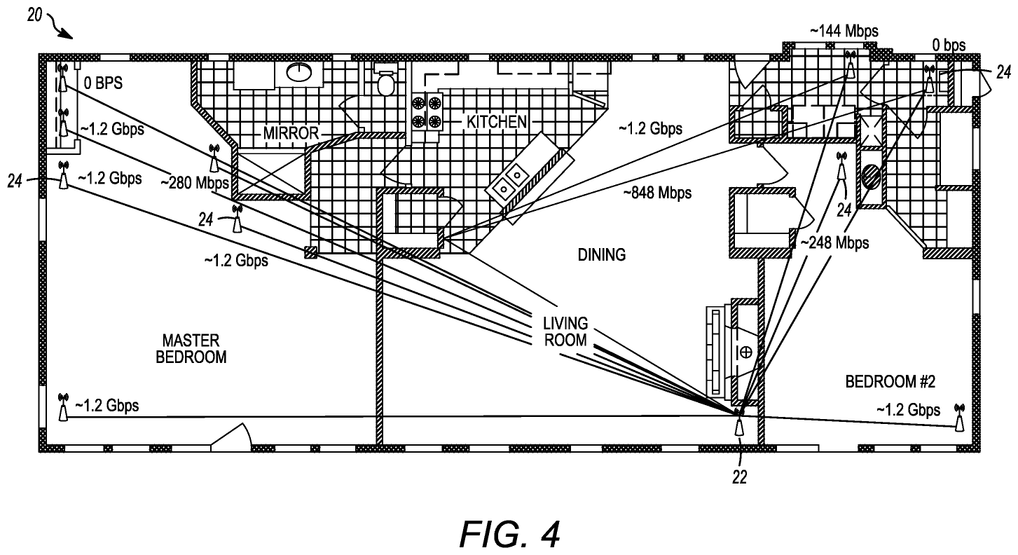

FIG. 4 shows a field test in a home environment 20 exemplifying conditions typically present in an actual home-network environment. For example, Bedroom 2 is a guest bedroom that is being used for storage and has fully packed boxes stacked high in the closet, and full boxes interspersed around the room. In this home-environment test, one Qualcomm (QCOM) unit 22 was configured as an Access point and was placed in a bookshelf next to the fireplace in the living room at approximately 3.5 feet high. This location was chosen as a standard location in the living room that one might place an AP. The other unit 24 was configured as a STA and placed at ten various locations, with the placement being tuned so that the antennas of the two units were facing each other. The Qualcomm 802.11ad has a highly directional antenna array, therefore, when the STA was placed into a different location, both the AP's orientation and the STA's orientation were adjusted and optimized for maximum throughput to demonstrate the full capabilities of an 802.11ad wireless home network.

Placing the AP in the location of the bookshelf by the fireplace presented many challenges. The AP was in a solid oak bookshelf next to a fireplace insert made of metal. Also, Bedroom #2 was being used for storage, with many boxes, small appliances, and another wood bookshelf for the signal to pass through to reach to the upper right corner of the house. With respect to the STA placements in the upper left corner of the house, the signal had to pass through a pantry, hallway and bathroom where the path through bathroom also took the signal into the shower, which has highly reflective surfaces. There was also a metal weight bench in the path between the AP and the STA about 3 feet before the closet in the Master Bedroom and at the same height as the Client was placed in the upper left corner of the room in the closet.

These conditions had a large effect on the link as can be seen by the performance metrics shown in FIG. 4; it was difficult to achieve association at all in the upper left and right corners of the house, and even when an association was achieved, data could not be passed. However, for the upper left corner of the house, a simple adjustment of the location of the Client by four feet, moving the Client from one side of the closet to the other, took the signal path out of the bathroom shower area and away from the weight bench and the maximum rates of these units.

Interestingly, to achieve connectivity and throughput in the upper right corner of the house, which achieved a maximum of approximately 250 Mbps when the directional antennas of the units were directly aligned towards each other, the inventors considered that it might be possible to route the directional signal between the antennas of the AP 22 and STA 24 around obstacles by pointing both antennas toward a mirror that was hanging on the Master Bedroom entryway wall. Through experimentation, when the AP 22 was kept at the same height and just pointed towards the mirror (through the pantry walls), the STA 24 had to be raised to a height of about 4.5 feet to get into the signal path created by the reflected signal; once the STA 24 was in that raised position, the rates went from about 144 Mbps in the laundry room to the 1.2 Gbps maximum rates these units are capable of. Moreover, where no association was previously achieved between the AP 22 and STA 24 in the water closet of the bathroom in Bedroom #2, about 848 Mbps was obtained through the signal reflected by the mirror. All rates at the locations where the signal was not passing through either the Master Bedroom bath or the storage in Bedroom #2 were at the maximum rates achievable by these units of about 1.2 Gbps.

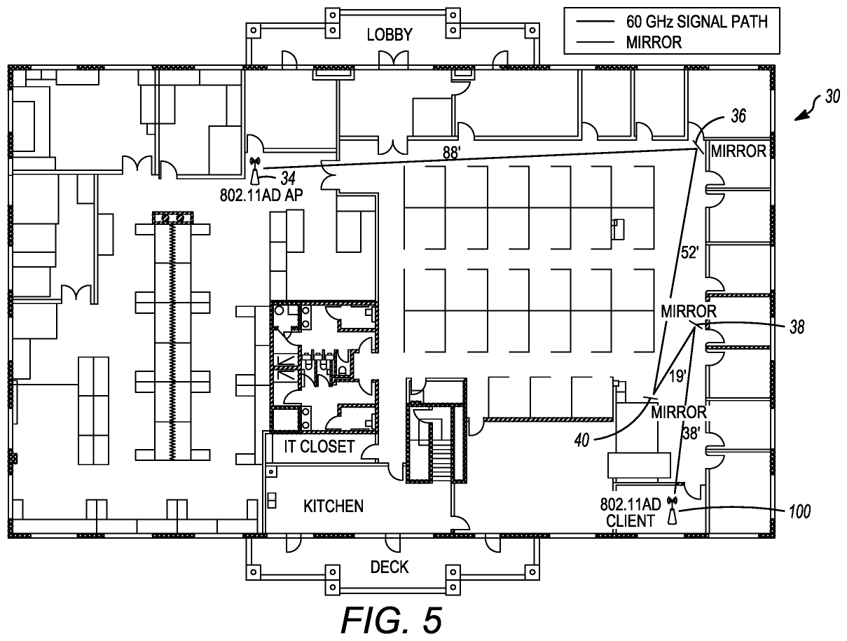

To further study the efficacy of using mirrors or other reflectors to aim directional 802.11ad wireless signals, further field tests were conducted in an office environment. FIG. 5, for example, shows a test configuration 30 in a large office space with multiple cubicles, hallways, and other obstructions. This particular field test was intended to study the effectiveness of smooth, flat reflective surfaces on redirecting wireless signals around obstacles.

As in previous tests, one Qualcomm unit was configured as an Access Point (AP) and the other unit configured as an STA 34. The AP 32 was placed at the far end of one of two intersecting hallways, about 100 linear feet away from the STA 34 which was positioned in a conference room at the end of the other hallway, with many obstructions between the two. Due to these obstructions, no association between the AP 32 and the STA 34 was expected, and indeed it was verified that no association could be obtained when the directional antennas of both units were pointed toward each other.

Three mirrors 36, 38, and 40 of different shapes and sizes were chosen for this test. Although a link could have been completed using only one mirror, three mirrors were used to maximize the distance of the signal path, and to see if multiple mirrors would degrade the signal as it travelled between the AP 32 and STA 34. Mirror 36 was a full-length mirror measuring 50″×14″ and was located 88 feet from the AP 32. Mirror 38 was an irregularly-shaped wall-mounted mirror with right angles and rounded sides, which measured 15″×15″ and was positioned 52 feet from Mirror 36. Mirror 40 was a wall-mounted mirror with bevelled edges and measuring 21.5″×25.5″ and was positioned 19 feet away from mirror 38 in the reverse direction mirror 36. Mirror 40 was 38 feet away from the STA 34. A laser pointer was taped to the top of the AP 32, and used to arrange and orient the mirrors so that the directional wireless 802.11ad signal would navigate the total path length of 197 feet between the AP 32 and the STA 34.

With the above configuration, the STA 34 was now able to see the AP 32 and associate. Iperf was used to pass traffic downstream, and the maximum rates that these units were capable of (about 1.2 Gbps) was achieved. To verify that the mirrored link was indeed the path the signal was taking, mirror 36 was removed from the link. At that point the association between the AP 32 and STA was lost. When mirror 36 was replaced and realigned, the AP 32 and STA 34 re-associated and began passing the maximum rates again. This procedure was also done with mirrors 38 and 40, which produced the same results.

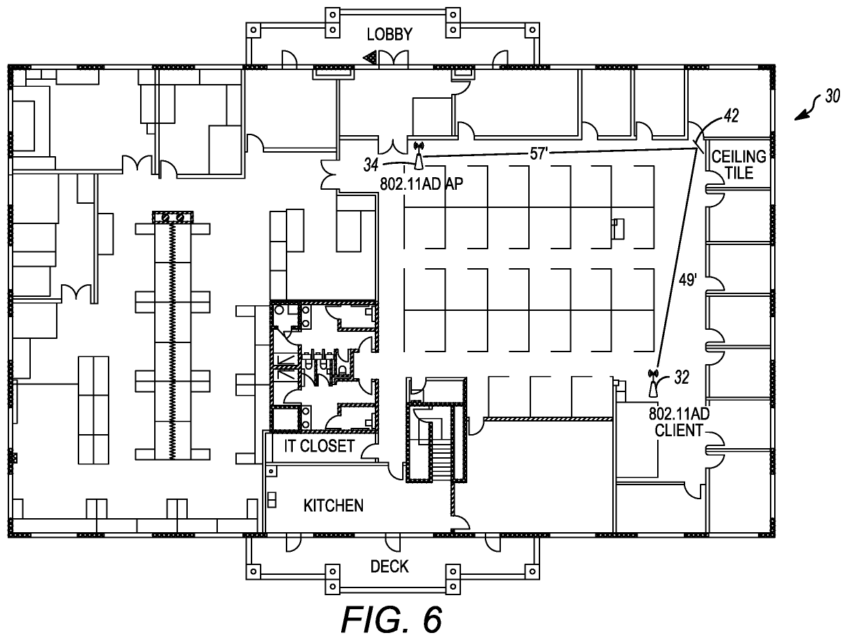

Another field test in an office environment was performed to determine the effectiveness of diffuse surfaces in redirecting 802.11ad wireless signals. Specifically, referring to FIG. 6, in the same office space as that shown in FIG. 5, the AP 32 was placed in the Lobby area approximately 57 feet from the corner intersection of the two hallways, and the STA 34 was again placed in the conference room at the end of the other hallway than that in which the AP 32 was placed. Both units had the main lobe of the 60 GHz signal pointed towards the same corner of the building, where the diffuse surface will be placed. An association between the AP and Client was established when the AP 32 and the STA 34 had their antennas pointed at the corner, with a throughput rate of about 285 Mbps.

For the diffuse reflecting surface, a spare ceiling tile was used that measures 24″×48″ and was made from porous mineral fiber material. The ceiling tile was placed in the corner that both of the 802.11ad units were pointing to, and both the front and back surfaces of the tile were tested for their reflecting ability. First the front of the ceiling tile was used as the reflecting surface then the back. As noted above, before the ceiling tile was put in place, the throughput between the AP 32 and the STA 34 was only about 285 Mbps. Once the tile was in place, the throughput rates jumped up to the maximum that these units are capable of, i.e., about 1.2 Gbps. Once the ceiling tile was removed, the rates dropped back to 285 Mbps and as soon as it was replaced, the throughput rate climbed back up to the maximum rate. This behavior was seen on both the front and back of the ceiling tile. Having few porous surfaces available, other random surfaces were tried, including a framed picture that was hanging on the wall and the front and back of a white board. All of them gave us the same identical results.

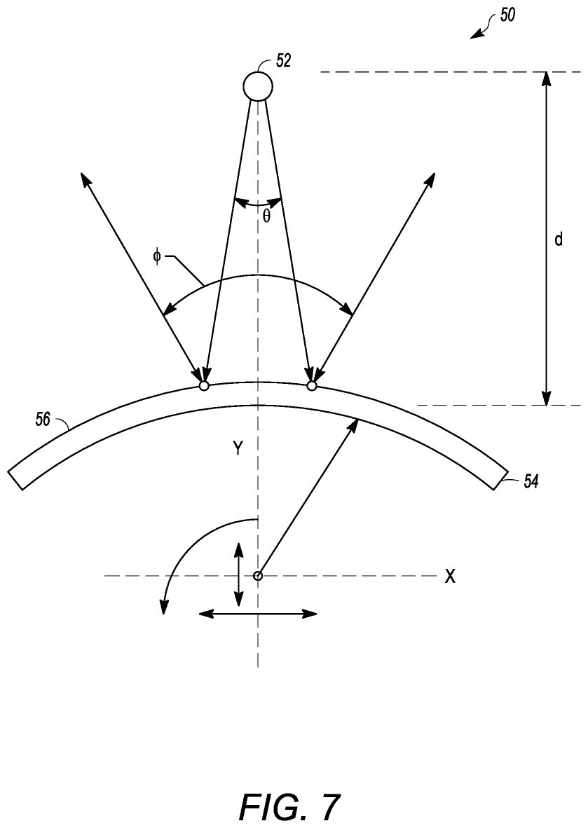

FIG. 7 shows an alternate system 50 where a directional antenna 52 is aimed at a near-field reflector 45 having a convex surface 56 facing the antenna 52. The signal propagating from the directional antenna 52 through a relatively small angle θ is therefore reflected from the surface 56 at a larger angle ϕ. As noted earlier, though dispersing an 802.11ad over a wider angle will improve coverage area, this benefit is achieved at the cost of losing range from free space loss and resonance with oxygen as the power of the signal is dispersed over a wider area. However, in many wireless environments, and particularly one in which the signal from the antenna 52—even as dispersed by the nearfield reflector 54—can be redirected around obstacles in a room as described earlier in this specification. Accordingly, in a preferred embodiment, the system 50 shown in FIG. 7 may be capable of adjustment, so as to select an appropriate angle of reflection off of the surface 56 of the near-field reflector 54. For example, the system 50 may be capable of adjusting the distance “d” between the reflector 54 by moving the reflector towards or away from the antenna along the y-axis shown in FIG. 7. Alternatively, or additionally the reflector 54 may be capable of aiming the signal reflected off of the surface 56 by moving the reflector 64 relative to the antenna 52 along the x-axis shown in FIG. 7, and/or by rotating the reflector 54 about the center of its radius of curvature. Those of ordinary skill in the are will readily appreciate that any or all of these adjustment mechanisms may be physically implemented in a variety of manners, e.g., an x-y stage positioner, etc.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

We claim:

1. An arrangement configured to establish a wireless network, the arrangement comprising:
an access point having a first directional antenna; and
a client device having a second directional antenna;
wherein the first directional antenna is aimed in a first direction substantially not toward the second directional antenna, and the second directional antenna is aimed in a second direction substantially not toward the first directional antenna.

2. The arrangement of claim 1 wherein the client device receives a wireless signal propagated from the access point.

3. The arrangement of claim 1 wherein the first directional antenna and the second directional antenna are aimed at a common location.

4. The arrangement of claim 1 further comprising a mirror that reflects wireless signals from the first directional antenna toward the second directional antenna.

5. The arrangement of claim 4 further comprising an additional one or more mirrors that together reflect the wireless signals from the first directional antenna toward the second directional antenna.

6. The arrangement of claim 4 wherein the mirror has a specular reflective surface.

7. The arrangement of claim 4 wherein the mirror has a diffuse reflective surface.

8. The arrangement of claim 1 wherein the first directional antenna and the second directional antenna are configured to communicate at a frequency between approximately 55 GHz and 65 GHz.

9. The arrangement of claim 1 wherein the wireless network conforms to the 802.11ad standard.

10. A method for establishing a wireless communications network for exchanging signals between an access point having a first directional antenna and a client device having a second directional antenna, the method comprising:
aiming the first directional antenna in a first direction substantially not toward the second directional antenna; and
aiming the second directional antenna in a second direction substantially not toward the first directional antenna;
wherein the client device receives a wireless signal propagated from the access point.

11. The method of claim 10 further comprising aiming the first directional antenna and the second directional antenna at a common location.

12. The method of claim 10 further comprising placing a mirror at a location that reflects wireless signals from the first directional antenna toward the second directional antenna.

13. The method of claim 12 further comprising placing one or more additional mirrors at locations such that the one or more additional mirrors together reflect the wireless signals from the first directional antenna toward the second directional antenna.

14. The method of claim 12 wherein the mirror has a specular reflective surface.

15. The method of claim 12 wherein the mirror has a diffuse reflective surface.

16. The method of claim 12 further comprising using a laser pointer to orient the mirror.

17. The method of claim 10 wherein the first directional antenna and the second directional antenna are configured to communicate at a frequency between approximately 55 GHz and 65 GHz.

18. The method of claim 10 wherein the wireless communications network conforms to the 802.11ad standard.

19. A system comprising:
a directional antenna capable of and configured for wireless communication in an 801.11ad wireless network;
a concave reflector, positioned proximate the directional antenna, that increases a propagation angle of a wireless signal from the directional antenna.

20. The system of claim 19 wherein an amount by which the concave reflector increases the propagation angle of the wireless signal is adjustable.
